(19) United States
(12) Patent Application Publication
(10) Pub. No.: US 2014/0163441 A1
(43) Pub. Date: Jun. 12, 2014

(54) Massage Device Capable of Kneading and Percussion

(71) Applicant: Jue-Yao Chen, Erlin Township (TW)

(72) Inventor: Jue-Yao Chen, Erlin Township (TW)

(21) Appl. No.: 13/707,674

(22) Filed: Dec. 7, 2012

(51) Int. Cl. A61H 99/00; A61H 23/00

(52) U.S. Cl. CPC A61H 99/00; A61H 23/00
USPC 601/111; 601/135

(57) ABSTRACT

A massage device capable of kneading and percussion is provided. Elements of the massage device and their interaction are as follows: a casing portion has therein a power source which is a motor for driving a first transmission member; the first transmission member drives a second transmission member; the second transmission member drives a rotational inclined surface structure; the rotational inclined surface structure drives an oscillating arm to undergo lateral oscillation; the oscillating arm is coupled to a massage head support, infrared lamp plates, and two massage heads, such that the two massage heads perform kneading-based massage; the first transmission member drives at least a third transmission member; and the at least a third transmission member drives an eccentric cam connected to an eccentric spindle and a lever weight for pulling the massage head support to perform percussion, thereby allowing the two massage heads to perform percussion-based massage.

### BACKGROUND OF THE INVENTION

1. Technical Field

The present invention relates to massage devices, and more particularly, to a massage device capable of kneading and percussion, wherein kneading with lateral oscillation is effected by a rotational inclined surface, and percussion by an eccentric cam.

2. Description of Related Art

People nowadays lead a stressful busy lifestyle and can only find peace of mind at home. However, just because you take a good rest at home, it doesn't mean that the back pain inflicting you due to busy lifestyle and work stress is likely to be relieved. In view of this, the related industrial sector developed a conventional massage apparatus whereby a user massages the body at home to freshen up and relieve back pain.

The conventional massage apparatus operates by simply rubbing or kneading parts of the body and thus cannot refresh the body efficiently. Furthermore, the conventional massage apparatus performs rubbing or kneading monotonously and invariably and thus offers few choices to consumers; as a result, the conventional massage apparatus fails to build customer loyalty. Accordingly, the prior art has room for improvement.

### SUMMARY OF THE INVENTION

It is an objective of the present invention to provide a massage device capable of kneading and percussion. The massage device is characterized in that a power source drives a rotational inclined surface and an eccentric cam, to thereby perform kneading with lateral oscillation by means of the rotational inclined surface and perform percussion by means of the eccentric cam. With a one-way bearing being disposed in the driving direction of the eccentric cam, the massage device in operation offers users two options, namely either kneading-based massage only, or both kneading-based massage and percussion-based massage.

In order to achieve the above and other objectives, the present invention provides a massage device capable of kneading and percussion. The massage device comprises a power source, a first transmission member, a second transmission member, at least a third transmission member, a casing portion, at least a kneading unit, and at least a percussion unit. The power source can be a motor. The motor drives a worm gear of the first transmission member. The worm gear drives a first gear of a first transmission shaft. A second gear of the first transmission shaft meshes with a large gear of the second transmission member. The large gear is fixed to a second transmission shaft. The second transmission shaft drives a rotational inclined surface structure. An oscillating arm abuts against the rotational inclined surface structure. The rotational inclined surface structure rotates to drive the oscillating arm to undergo lateral oscillation, thereby driving a massage head support to undergo lateral oscillation. Massage heads and infrared lamp plates rest on the massage head support. The massage heads undergo lateral oscillation and thereby perform kneading-based massage on the human body, whereas the infrared lamp plates are effective in applying a heat treatment. The first transmission member drives a third gear that comes with a one-way bearing. The third gear drives a fourth gear of the at least a third transmission member. The fourth gear and a fifth gear are fixed to a third transmission shaft. The fifth gear meshes with a sixth gear fixed to a fourth transmission shaft. An eccentric cam is disposed around the fourth transmission shaft. The eccentric cam is pivotally coupled to an eccentric spindle and thereby connected to a lever weight. The lever weight is fixed to the massage head support laterally. Hence, given reverse-rotation operation of the motor, the eccentric cam drives the massage heads to perform percussion-based massage and kneading-based massage simultaneously.

### BRIEF DESCRIPTION OF THE DRAWINGS

FIG. 1 is a perspective view of a massage device according to an embodiment of the present invention;

FIG. 2 is a schematic exploded view of the massage device according to an embodiment of the present invention;

FIG. 3 is a top view of a driving mechanism of the massage device according to an embodiment of the present invention;

FIG. 4 is a cutaway view of the massage device with a casing portion thereof missing according to an embodiment of the present invention;

FIG. 5 is a schematic view of kneading and percussion effected by the massage device according to an embodiment of the present invention;

FIG. 6 is a schematic front perspective view of the massage device disposed in a streamlined massage apparatus according to an embodiment of the present invention; and

FIG. 7 is a schematic rear perspective view of the massage device disposed in the streamlined massage apparatus according to an embodiment of the present invention.

### DETAILED DESCRIPTION OF THE EMBODIMENTS OF THE INVENTION

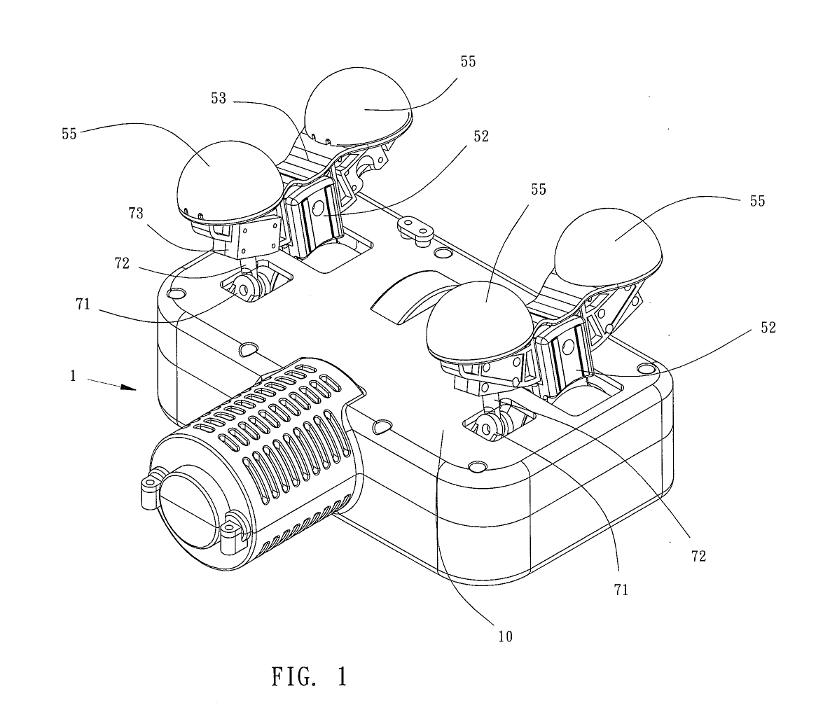

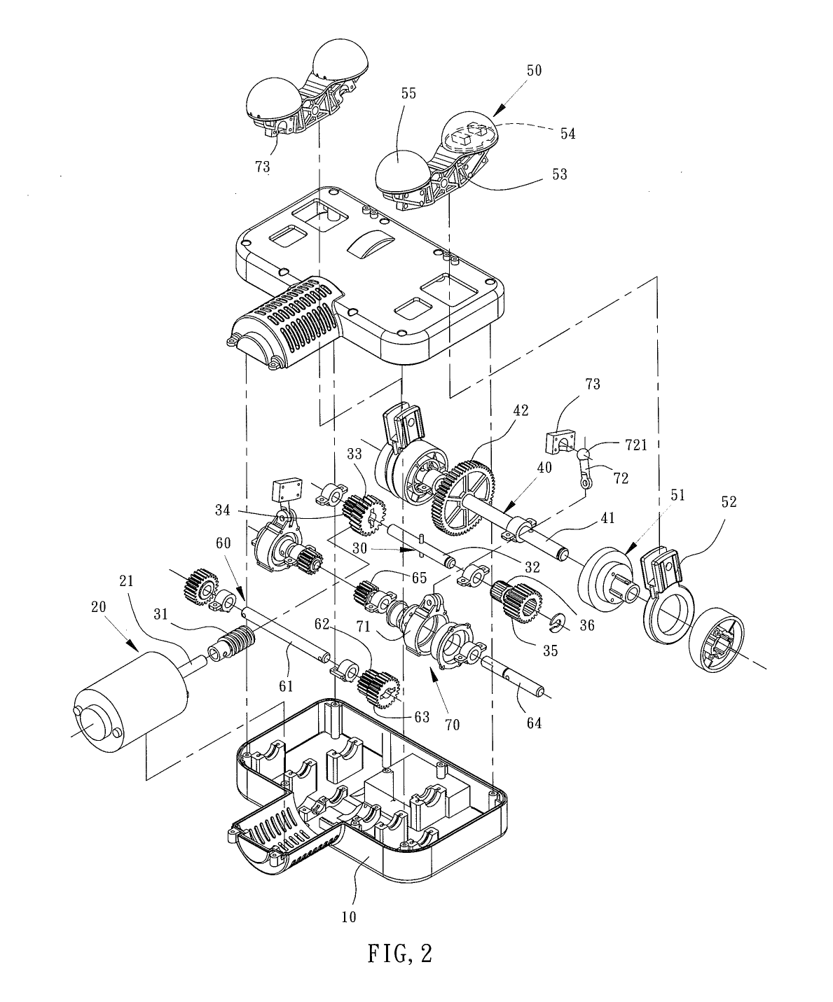

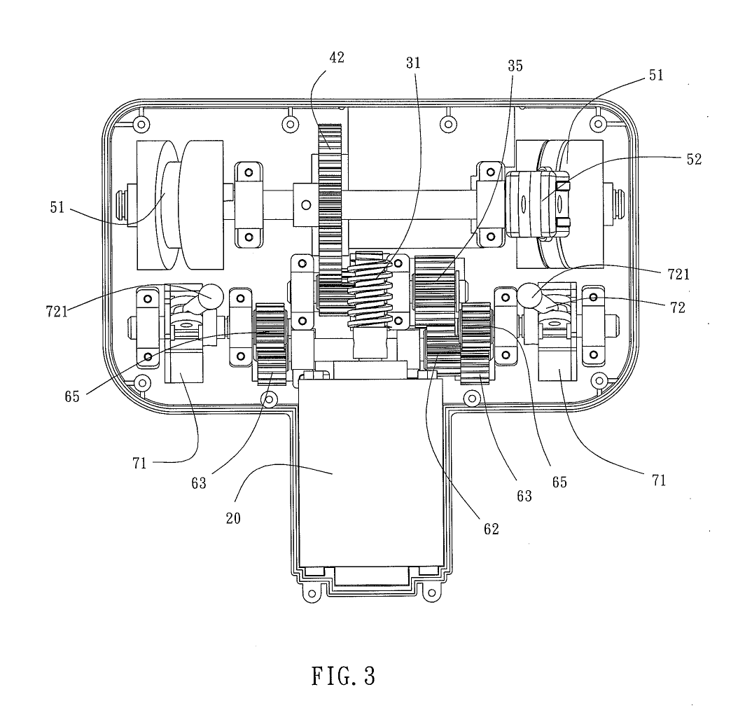

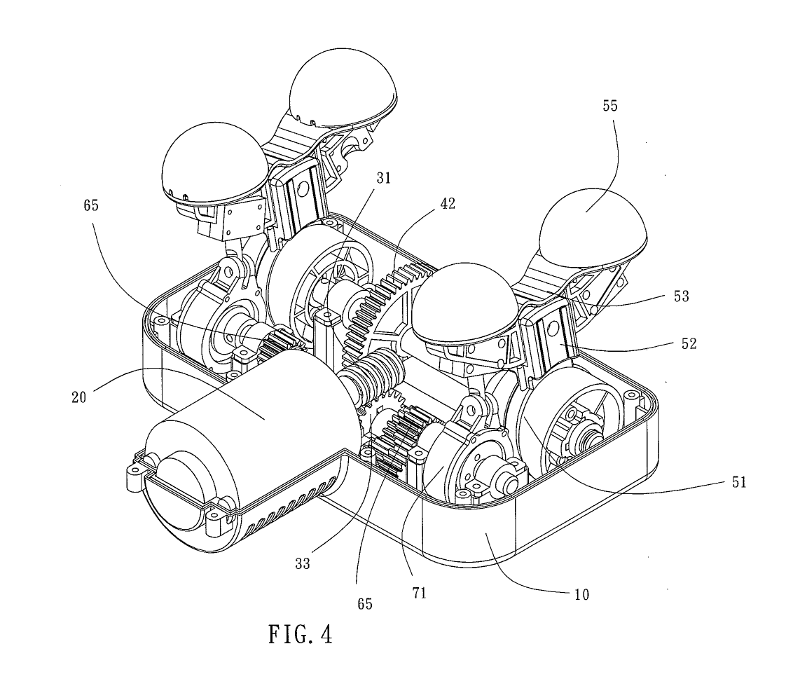

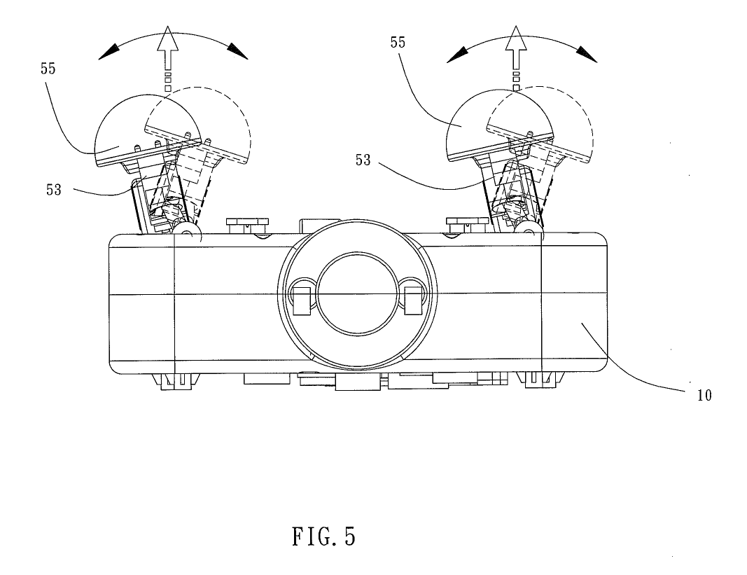

Referring to FIG. 1 through FIG. 5, the present invention provides a massage device 1 capable of kneading and percussion. The massage device 1 comprises a casing portion 10, a power source 20, a first transmission member 30, a second transmission member 40, at least a kneading unit 50, at least a third transmission member 60, and at least a percussion unit 70.

The power source 20, which can be a motor, is disposed in the casing portion 10.

The first transmission member 30 is disposed in the casing portion 10. The first transmission member 30 comprises a worm gear 31, a first transmission shaft 32, a first gear 33, a second gear 34, and a third gear 35. A spindle 21 of the motor 20 is fixed to the worm gear 31. The spindle 21 of the motor 20 rotates to drive the worm gear 31 to rotate. The first gear 33 is fixed to the first transmission shaft 32. A one-way bearing 36 is disposed at the second gear 34 and the first transmission shaft 32. The third gear 35 is disposed at the periphery of the one-way bearing 36. The worm gear 31 drives the first gear 33 fixed to the first transmission shaft 32.

The second transmission member 40 is disposed in the casing portion 10. The second transmission member 40 comprises a second transmission shaft 41 and a large gear 42. The second gear 34 of the first transmission member 30 meshes with the large gear 42 of the second transmission member 40. The large gear 42 is fixed to the second transmission shaft 41 to thereby drive the second transmission shaft 41 to rotate.

The at least a kneading unit 50 protrudes from the casing portion 10. The at least a kneading unit 50 comprises a rotational inclined surface structure 51, an oscillating arm 52, a massage head support 53, two infrared lamp plates 54, and two massage heads 55. The rotational inclined surface structure 51 is fixed to the second transmission shaft 41, such that the second transmission shaft 41 rotates to drive the rotational inclined surface structure 51 to rotate. The oscillating arm 52 abuts against the rotational inclined surface structure 51. The rotational inclined surface structure 51 rotates to drive the oscillating arm 52 to undergo lateral oscillation. The oscillating arm 52 is coupled to the massage head support 53 to thereby drive the massage head support 53 to undergo lateral oscillation. Infrared lamp plates 54 and massage heads 55 rest on the massage head support 53. The massage heads 55 undergo lateral oscillation and thereby perform kneading-based massage on the human body, whereas the infrared lamp plates 54 are effective in applying a heat treatment.

The at least a third transmission member 60 is disposed in the casing portion 10. The at least a third transmission member 60 comprises a third transmission shaft 61, a fourth gear 62, a fifth gear 63, a fourth transmission shaft 64, and a sixth gear 65. The first transmission member 30 drives the third gear 35 that comes with the one-way bearing 36. The third gear 35 drives the fourth gear 62 of the at least a third transmission member 60. The fourth gear 62 and the fifth gear 63 are fixed to the third transmission shaft 61. The fifth gear 63 meshes with the sixth gear 65 fixed to the fourth transmission shaft 64.

The at least a percussion unit 70 protrudes from the casing portion 10. The at least a percussion unit 70 comprises an eccentric cam 71, an eccentric spindle 72, and a lever weight 73. The eccentric cam 71 is disposed around the fourth transmission shaft 64. The eccentric cam 71 is pivotally coupled to the eccentric spindle 72 that comes with a universal joint 721 connected to the lever weight 73. The lever weight 73 is fixed to the massage head support 53 laterally. Hence, give reverse-rotation operation of the motor 20, the eccentric cam 71 drives the massage heads 55 to perform percussion-based massage and kneading-based simultaneously.

With the same aforesaid elements and interaction thereof, the massage device 1 capable of kneading and percussion is further characterized in that forward rotation of the spindle 21 of the motor 20 drives the first transmission shaft 32 and the first gear 33 of the first transmission member 30, such that the second gear 34 drives the large gear 42 and the second transmission shaft 41 to rotate; as a result, the second transmission shaft 41 rotates to drive the rotational inclined surface structure 51 to rotate, and the rotational inclined surface structure 51 rotates to drive the oscillating arm 52 to undergo lateral oscillation, thereby driving the massage head support 53 and the two massage heads 55 to undergo lateral oscillation kneading-based massage.

With the same aforesaid elements and interaction thereof, the massage device 1 capable of kneading and percussion is further characterized in that reverse rotation of the spindle 21 of the motor 20 drives the first transmission shaft 32 and the first gear 33 of the first transmission member 30, such that the second gear 34 drives the large gear 42 and the second transmission shaft 41; as a result, the second transmission shaft 41 rotates to drive the rotational inclined surface structure 51 to rotate, and the rotational inclined surface structure 51 rotates to drive the oscillating arm 52 to undergo lateral oscillation, thereby driving the massage head support 53 and the two massage heads 55 to undergo lateral oscillation kneading-based massage. Furthermore, under a reverse rotational force, the first transmission shaft 32 drives the third gear 35 by means of the one-way bearing 36, and then the third gear 35 drives the third transmission shaft 61 and the fourth gear 62 of the at least a third transmission member 60. The fifth gear 63 drives the sixth gear 65 and the fourth transmission shaft 64 to rotate. The fourth transmission shaft 64 drives the cam 71 of the at least a percussion unit 70 to rotate, and thus the eccentric cam 71 pushes or pulls the eccentric spindle 72 to move the lever weight 73 and thereby the massage head support 53, such that the two massage heads 55 perform kneading-based massage and percussion-based massage simultaneously.

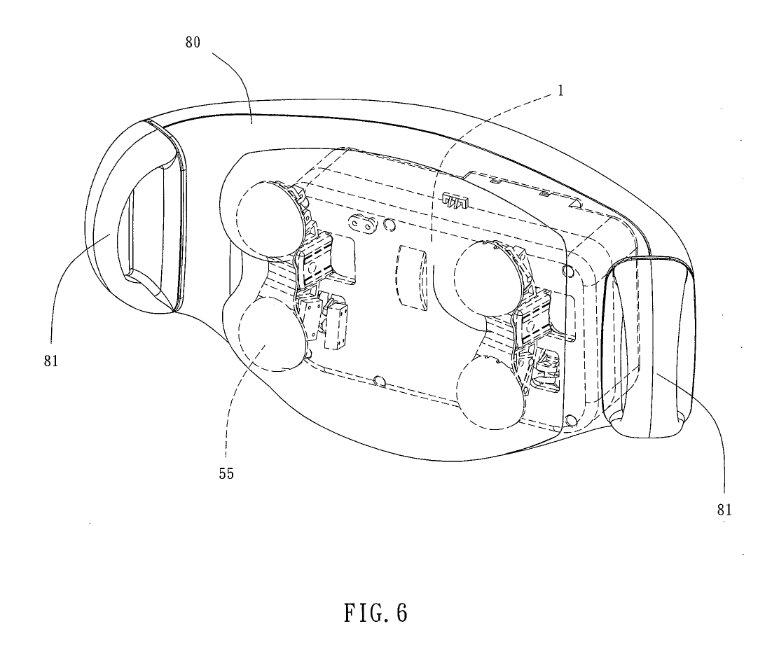

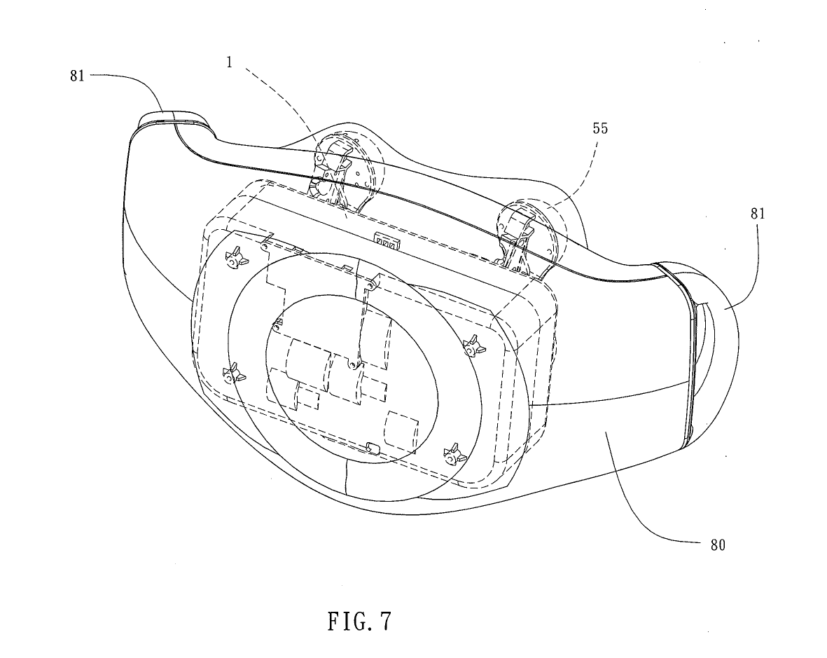

Referring to FIG. 6 and FIG. 7, the massage device 1 of the present invention can be disposed in a massage apparatus 80 in a manner that the massage heads 55 of the massage device 1 face a curved inner surface of the massage apparatus 80. Each of the two ends of the massage apparatus 80 has a handle 81 for a user to grip, thereby allowing a user to press the massage device 1 against the user's back to perform kneading-based and percussion-based massage thereon.

What is claimed is:

1. A massage device capable of kneading and percussion, the massage device comprising:
a casing portion;
a power source being a motor disposed in the casing portion;
a first transmission member disposed in the casing portion and comprising a worm gear, a first transmission shaft, a first gear, a second gear, and a third gear, the worm gear being fixed in place and driven to rotate by a spindle of the motor, the first and second gears being fixed to the first transmission shaft, wherein a one-way bearing is disposed at the first transmission shaft, and the third gear is disposed at a periphery of the one-way bearing, thereby allowing the worm gear to drive the first gear;
a second transmission member disposed in the casing portion and comprising a second transmission shaft and a large gear fixed to the second transmission shaft, wherein the second gear of the first transmission member meshes with the large gear of the second transmission member to thereby drive the second transmission shaft to rotate;
at least a kneading unit protruding from the casing portion and comprising a rotational inclined surface structure, an oscillating arm, a massage head support, and two massage heads, the rotational inclined surface structure being fixed to the second transmission shaft to allow the second transmission shaft to rotate and drive the rotational inclined surface structure to rotate, the oscillating arm abutting against the rotational inclined surface structure, the rotational inclined surface structure rotating to drive the oscillating arm to undergo lateral oscillation, the oscillating arm being coupled to the massage head support and adapted to drive the massage head support to undergo lateral oscillation, wherein the massage heads rest on the massage head support and undergo lateral oscillation to perform kneading-based massage;
at least a third transmission member disposed in the casing portion and comprising a third transmission shaft, a fourth gear, a fifth gear, a fourth transmission shaft, and a sixth gear, the first transmission member driving the third gear having the one-way bearing, the third gear driving the fourth gear of the at least a third transmission member, wherein the fourth gear and the fifth gear are fixed to the third transmission shaft, and the fifth gear meshes with the sixth gear fixed to the fourth transmission shaft; and
at least a percussion unit protruding from the casing portion and comprising an eccentric cam, an eccentric spindle, and a lever weight, wherein the eccentric cam is disposed around the fourth transmission shaft and pivotally coupled to the eccentric spindle having a universal joint connected to the lever weight, the lever weight being fixed to the massage head support laterally, such that, given reverse-rotation operation of the motor, the eccentric cam drives the massage heads to perform percussion-based massage and kneading-based massage simultaneously.

2. The massage device of claim 1, wherein the two massage heads each have an infrared lamp plate disposed therein for providing a heat treatment to supplement the massage.

3. The massage device of claim 1, wherein the massage device is disposed in a massage apparatus, wherein the massage heads of the massage device face a curved inner surface of the massage apparatus, wherein two handles are disposed at two ends of the massage apparatus, respectively, for a user to grip, wherein the massage apparatus corresponds in curvature to the user's back.
